(19) United States
(12) Patent Application Publication
(10) Pub. No.: US 2014/0020554 A1
(43) Pub. Date: Jan. 23, 2014

(54) Air Pump Cylinder

(71) Applicant: Wei-Chi Wang, Tainan City (TW)

(72) Inventor: Wei-Chi Wang, Tainan City (TW)

(21) Appl. No.: 13/552,703

(22) Filed: Jul. 19, 2012

(51) Int. Cl. F16J 10/02

(52) U.S. Cl. 92/169.1

(57) ABSTRACT

An air pump cylinder has a mounting bracket, a housing, a cover and an O-ring. The mounting bracket is made of metal and includes a rear wall and opposite sidewalls. The rear wall has a rear projection extending therefrom. Each sidewall has a side projection extending therefrom. The housing is made of metal and is clamped between the sidewalls of the mounting bracket. The cover is hermetically attached to the housing and includes a cap. The cap has a plurality of upper projections extending from an annular sidewall thereof and secured to the projections of the mounting bracket by bolts. The O-ring is compressed between the cover and the housing. Therefore, the structure of the air pump cylinder is simplified and manufacturing time and cost are reduced. Besides, the housing can be firmly held in the mounting bracket, thereby providing improved assembly stability.

### BACKGROUND OF THE INVENTION

1. Field of the Invention

The present invention relates to an air pump, and more particularly to an air pump cylinder with simplified structure to reduce manufacturing time and cost and to provide improved assembly stability.

2. Description of the Prior Arts

An air pump is used to pump air and is driven by electricity or manual power. With reference to FIGS. 6 and 7, a conventional air pump driven by electricity comprises an air pump cylinder 60 and an electric drive mechanism. The air pump cylinder 60 includes a mounting bracket 61, a housing 62, a cover 63, a connector 64 and two O-rings 633, 642. The mounting bracket 61 is formed by cutting and bending sheet metal into a rear wall 611, opposite sidewalls 612 and opposite top walls 613. Each top wall 613 has two threaded holes therethrough. The housing 62 is received in the mounting bracket 61 and has a tubular member 621, a flange 622 and a piston chamber 623. The flange 622 extends from a top end of the tubular member 621, is placed over the top walls 613 of the mounting bracket 61 and has four through holes therethrough in alignment with the threaded holes of the top walls 613 of the mounting bracket 61. The piston chamber 623 is defined in the tubular member 621. The cover 63 is hermetically attached to the housing 62 and has a center, a periphery, a flange 631 and a central hole 632. The flange 631 extends from the periphery of the cover 62, is placed over the flange 622 of the housing 62 and has four through holes therethrough in alignment with the through holes of the flange 622 of the housing 62. The central hole 632 is formed through the center of the cover 63 and communicates with the piston chamber 623 of the housing 62. One O-ring 633 is compressed between the cover 63 and the housing 62.

The connector 64 is hermetically attached to the cover 63 and has an outer surface, a valve chamber, two connecting members 641 and two projections 643. The valve chamber is defined in the connector 64 for receiving a valve 90 that includes a body 91 and a spring 92. The connecting members 641 extend from the outer surface of the connector 64. A pipe has one end connected to one of the connecting members 641 and the other end connected to an inflatable article such as a tire tube. The other connecting member 641 is connected to a pressure gauge. The projections 643 extend from the outer surface of the connector 64, are placed over the flange 631 of the cover 63 and each projection 643 has a through hole therethrough. The through holes of the two projections 643 align with two of the through holes of the flange 631 of the cover 63. Two bolts pass respectively through two groups of aligned through holes of the projections 643 of the connector 64, the flange 631 of the cover 63 and the flange 622 of the housing 62 and are screwed into the two threaded holes of the top walls 613 of the mounting bracket 61. Two bolts pass respectively through the other two groups of aligned through holes of the flange 631 of the cover 63 and the flange 622 of the housing 62 and are screwed into the other two threaded holes of the top walls 613 of the mounting bracket 61. The other O-ring 642 is compressed between the connector 64 and the cover 63.

The electric drive mechanism includes a motor 80 and a gearing 81. The motor 80 and the gearing 81 are mounted on the rear wall 611 of the mounting bracket 61 of the air pump cylinder 60.

In operation, the motor 80 drives a piston rod 70 to move in a reciprocating motion in the piston chamber 623 of the housing 62 of the air pump cylinder 60 via the gearing 81. With reference to FIG. 8, each time a piston 71 of the piston rod 70 is moved toward the valve 90, air is compressed by the piston 71. The compressed air pushes the body 91 against a restoring force of the spring 92 to open the central hole 632 of the cover 63 of the air pump cylinder 60 and then ejects into the inflatable article through the connecting member 641 of the connector 64 for inflating the inflatable article. With reference to FIG. 9, each time the piston 71 of the piston rod 70 is moved away from the valve 90, a negative pressure in the piston chamber 623 is generated so that ambient air can flow into the piston chamber 623 through a check valve 72 of the piston rod 70. Thus, a pumping effect is achieved.

However, the housing 62 cannot be firmly held in the mounting bracket 61 because the housing 62 is secured to the mounting bracket 61 only by the bolts inserted through the flange 622 of the housing 62 and the top walls 613 of the mounting bracket 61. In addition, the air pump cylinder 60 is composed of too many elements including the mounting bracket 61, the housing 62, the cover 63, the connector 64 and the O-rings 633, 642, which increases manufacturing time and cost.

To overcome the shortcomings, the present invention provides an air pump cylinder to mitigate or obviate the aforementioned problems.

### SUMMARY OF THE INVENTION

The main object of the present invention is to provide an air pump cylinder with simplified structure to reduce manufacturing time and cost and to provide improved assembly stability.

To achieve the foregoing objective, the air pump cylinder in accordance with the present invention comprises a mounting bracket, a housing, a cover and an O-ring. The mounting bracket is made of metal and includes a rear wall and opposite sidewalls. The rear wall has a rear projection extending therefrom. Each sidewall has a side projection extending therefrom. The housing is made of metal, is clamped between the sidewalls of the mounting bracket and includes a tubular member, a piston chamber and a central hole. The tubular member has a closed top. The piston chamber is defined in the tubular member. The central hole is formed through a center of the closed top of the tubular member and communicates with the piston chamber. The cover is hermetically attached to the housing and includes a cap and a first connecting member. The cap has a closed top, an annular sidewall, a valve chamber and a plurality of upper projections. The valve chamber is defined between the closed top and the annular sidewall of the cap and communicates with the piston chamber through the central hole of the housing. The upper projections extend from an outer surface of the annular sidewall of the cap and are secured to the projections of the mounting bracket by bolts. The first connecting member extends from the closed top of the cap and has a passage defined therein and communicating with the valve chamber of the cap. The O-ring is compressed between the cap of the cover and the closed top of the housing. Therefore, the structure of the air pump cylinder is simplified and manufacturing time and cost are reduced. Besides, the housing can be firmly held in the mounting bracket, thereby providing improved assembly stability.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an air pump with an air pump cylinder in accordance with the present invention;

FIG. 2 is an exploded perspective view of the air pump with the air pump cylinder in FIG. 1;

FIG. 3 is a side view in partial section of the air pump with the air pump cylinder in FIG. 1;

FIGS. 4 and 5 are cross-sectional front views of the air pump with the air pump cylinder in FIG. 1 showing that the air pump is pumping air;

FIG. 6 is a perspective view of a conventional air pump in accordance with the prior art;

FIG. 7 is an exploded perspective view of the conventional air pump in FIG. 6; and

FIGS. 8 and 9 are cross-sectional front views of the conventional air pump in FIG. 6 showing that the air pump is pumping air.

### DETAILED DESCRIPTION OF THE PREFERRED EMBODIMENTS

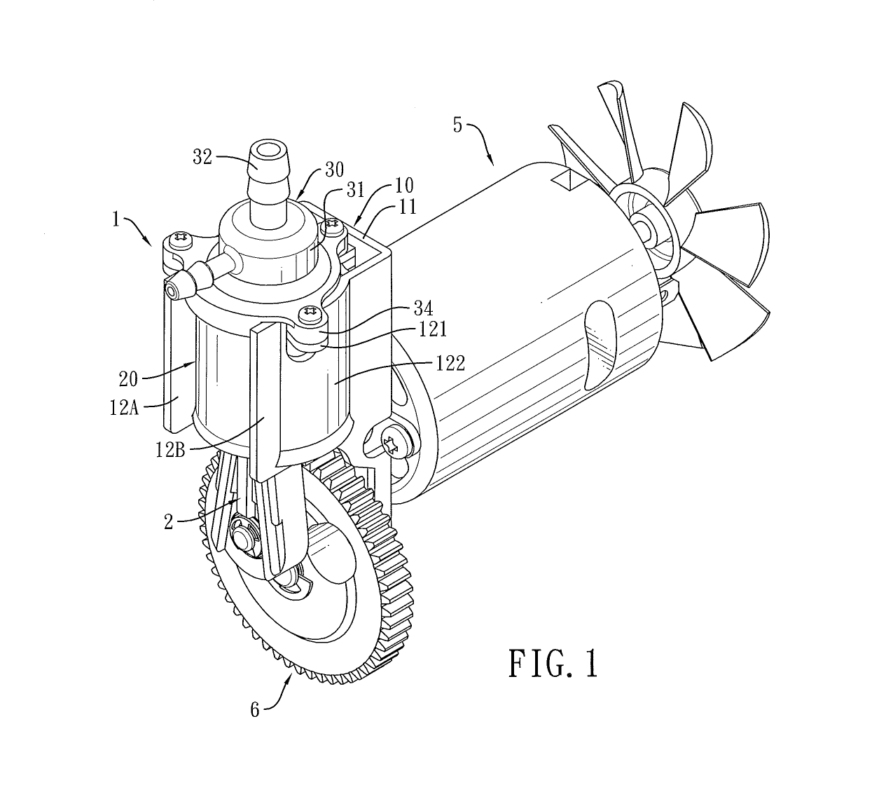

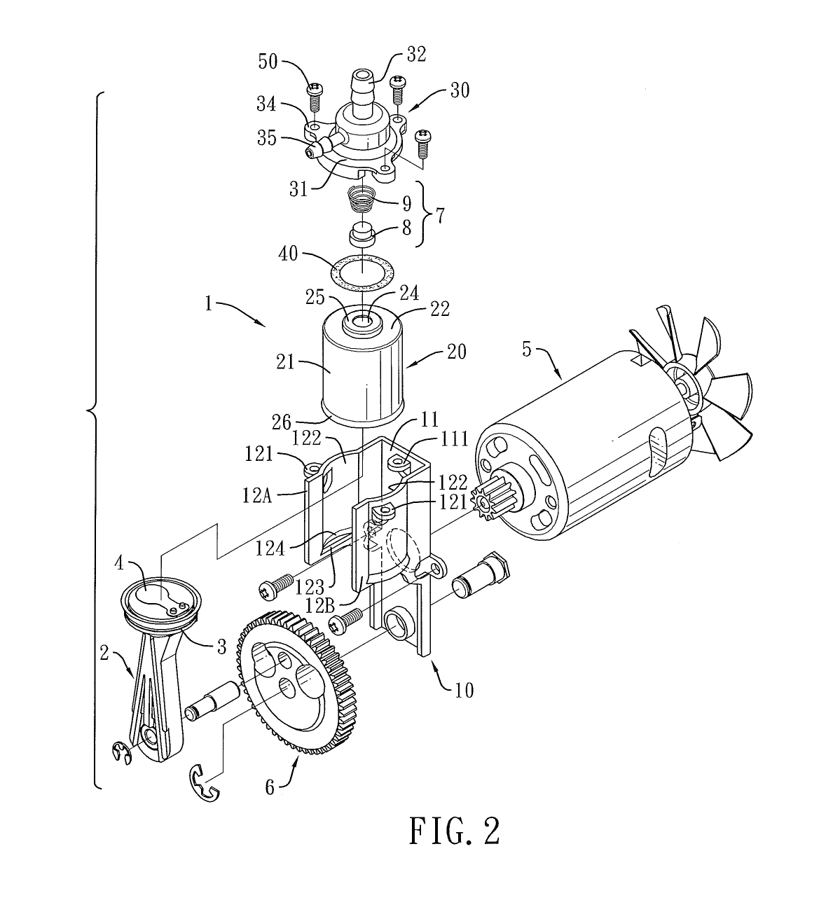

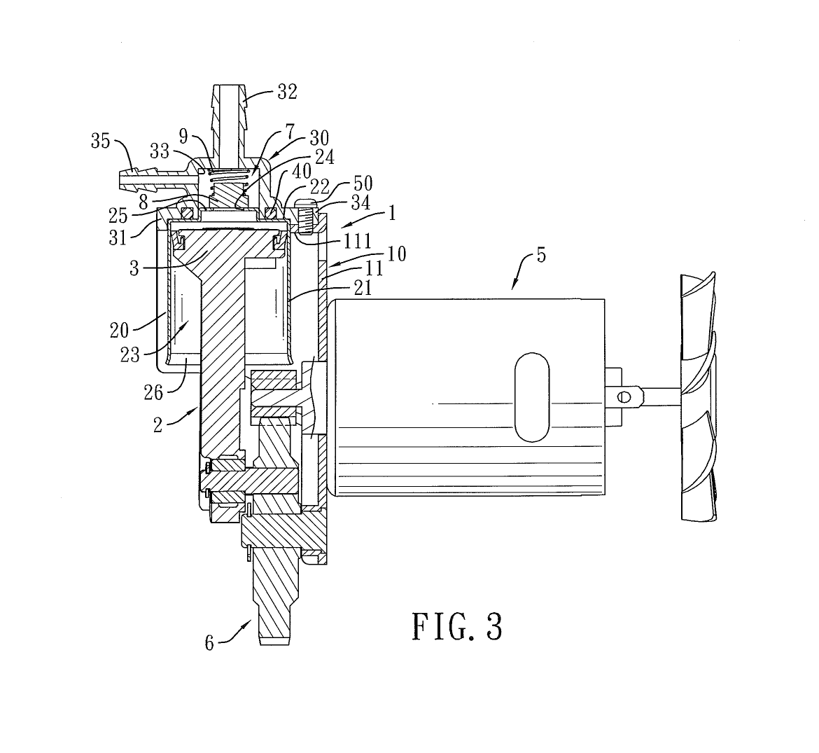

With reference to FIGS. 1 to 3, an air pump cylinder 1 in accordance with the present invention comprises a mounting bracket 10, a housing 20, a cover 30 and an O-ring 40.

The mounting bracket 10 is made of metal and includes a rear wall 11 and opposite sidewalls 12A, 12B. The rear wall 11 has a rear projection 111 extending therefrom. Each sidewall 12A, 12B has a side projection 121 extending therefrom. Each of said projections 111, 121 has a fastening hole therethrough. The fastening hole may be a threaded hole. The mounting bracket 10 may be formed by punching and bending sheet iron.

The housing 20 is made of metal, is clamped between the sidewalls 12A, 12B of the mounting bracket 10 and includes a tubular member 21, a piston chamber 23 and a central hole 24. The tubular member 21 has a closed top 22 and an open bottom 26. The piston chamber 23 is defined in the tubular member 21. A piston rod 2 is inserted in the piston chamber 23 from the open bottom 26. The central hole 24 is formed through a center of the closed top 22 of the tubular member 21 and communicates with the piston chamber 23.

The cover 30 is hermetically attached to the closed top 22 of the housing 20 and includes a cap 31 and a first connecting member 32. The cap 31 has a closed top, an open bottom, an annular sidewall, a valve chamber 33 and a plurality of upper projections 34. The valve chamber 33 is defined between the closed top and the annular sidewall of the cap 31 for receiving a valve 7 that includes a body 8 and a spring 9. The valve chamber 33 communicates with the piston chamber 23 through the central hole 24 of the housing 20. The upper projections 34 extend from an outer surface of the annular sidewall of the cap 31, are adjacent to the open bottom of the cap 31 and correspond to the projections 111, 121 of the mounting bracket 10. Each upper projection 34 has a through hole therethrough in alignment with the fastening hole of a corresponding projection 111, 121 of the mounting bracket 10. Bolts 50 pass through the through holes of the projections 34 of the cover 30 and are screwed into the fastening holes of the projections 111, 121 of the mounting bracket 10 to firmly secure the cover 30, the housing 20 and the mounting bracket 10 together. The first connecting member 32 extends axially from an outer surface of the closed top of the cap 31 and has a passage defined therein and communicating with the valve chamber 33 of the cap 31. The first connecting member 32 is connected to one end of a pipe and the other end of the pipe is connected to an inflatable article. The cover 30 is made of metal or plastic, preferably plastic.

The O-ring 40 is compressed between the cap 31 of the cover 30 and the closed top 22 of the housing 20.

In a preferred embodiment, the rear projection 111 extends from an inner surface of the rear wall 11 of the mounting bracket 10 and the side projections 121 extend from outer surfaces of the sidewalls 12A, 12B of the mounting bracket 10. Each sidewall 12A, 12B has a recess 122 formed in an inner surface thereof so as to form a support portion 123 below the recess 122. The recess 122 may be curved, polygonal or in any other geometric shape and has a flared section 124 adjacent to the support portion 123. The tubular member 21 of the housing 20 is clamped between the recesses 122, is supported by the support portions 123 and includes an insertion portion 25. The insertion portion 25 is formed on an outer surface of the closed top 22 of the tubular member 21, is inserted in the valve chamber 33 of the cap 31 of the cover 30 and has a center and an abutting surface. The central hole 24 is formed through the center of the insertion portion 25. The abutting surface is formed around the central hole 24. The body 8 of the valve 7 abuts the abutting surface. The spring 9 of the valve 7 is compressed between the body 8 of the valve 7 and an inner surface of the closed top of the cap 31 of the cover 30. The open bottom 26 of the tubular member 21 is flared and is fitted with the flared sections 124 of the recesses 122. The flared open bottom 26 allows a piston 3 of the piston rod 2 to be conveniently put in the piston chamber 23 and reinforces the tubular member 21.

The cap 31 of the cover 30 has three upper projections 34 corresponding to the three projections 111, 121 of the mounting bracket 10. The cover 30 includes a second connecting member 35. The second connecting member 35 extends radially from the outer surface of the annular sidewall of the cap 31 and has a passage defined therein and communicating with the valve chamber 33 of the cap 31. The second connecting member 35 is connected to a pressure gauge.

The air pump cylinder 1 in accordance with the present invention is composed of fewer elements as compared with the conventional air pump cylinder so that the air pump cylinder 1 of the present invention is simplified and reduces manufacturing time and cost. Besides, the housing 20 can be held firmly in the mounting bracket 10, thereby providing improved assembly stability.

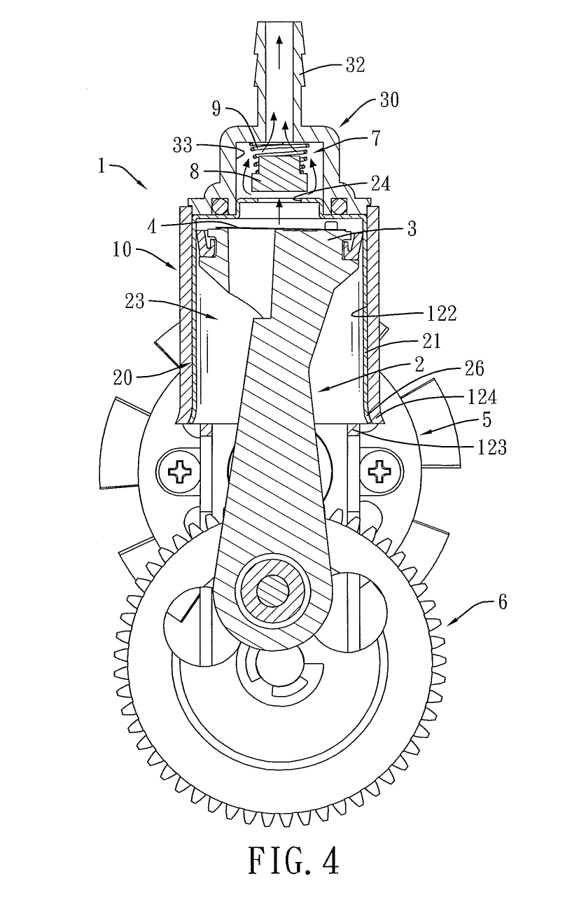

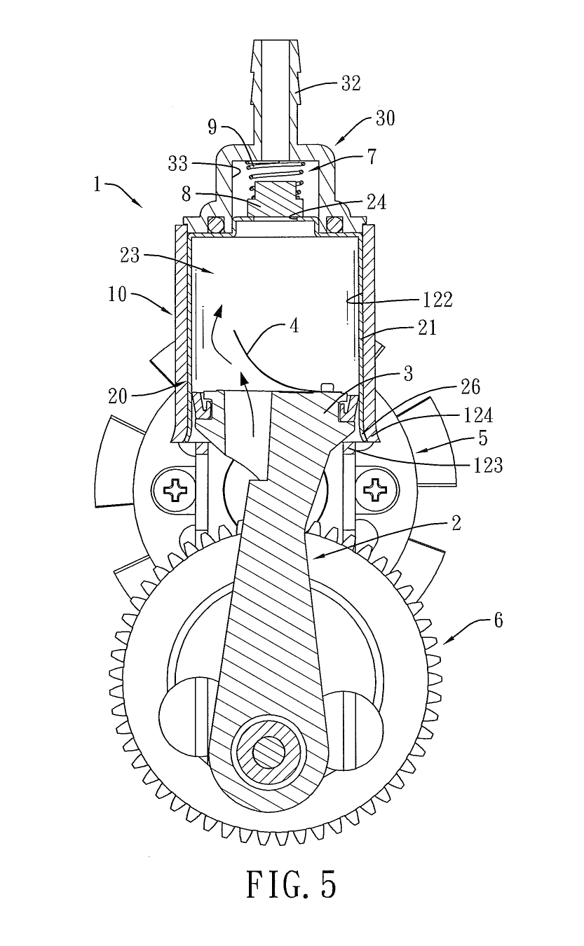

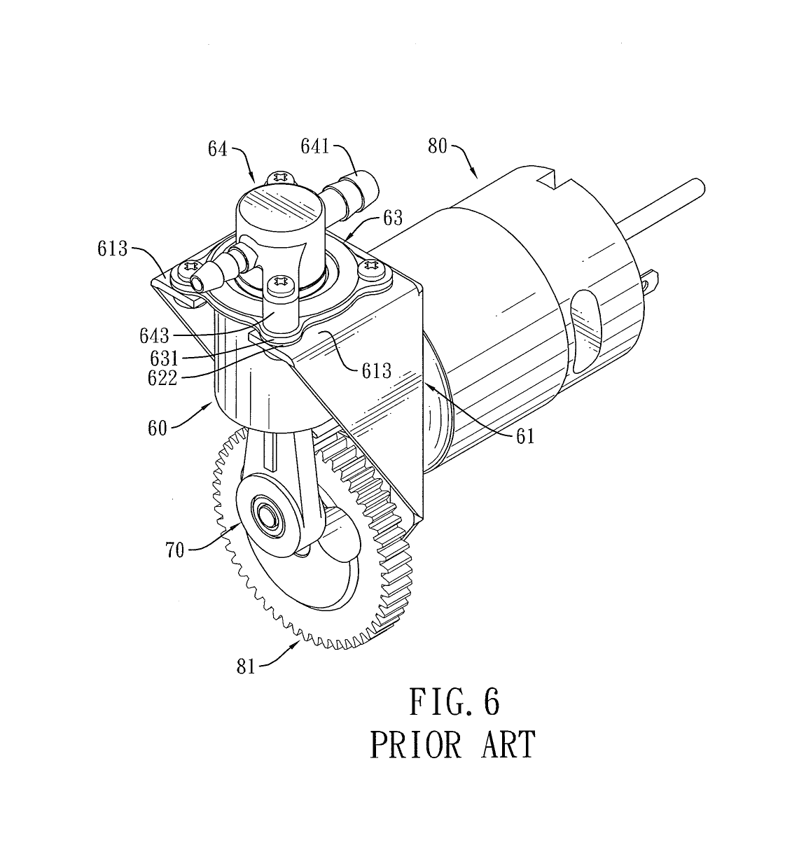

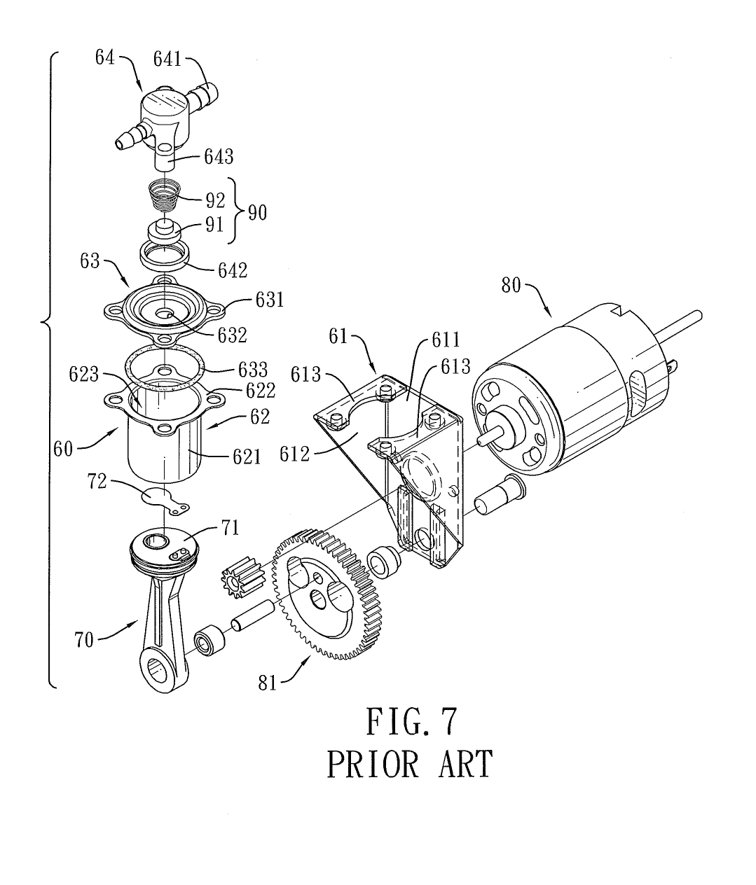

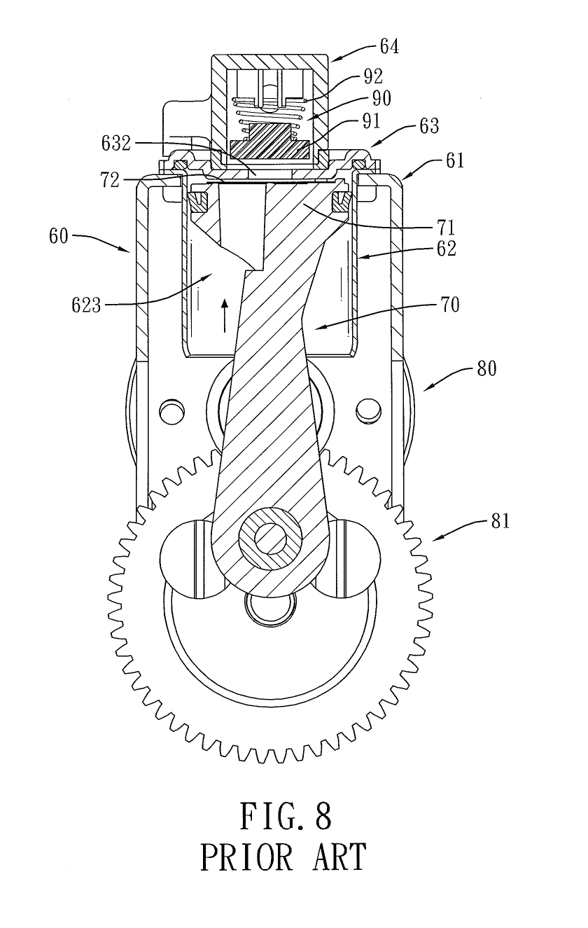

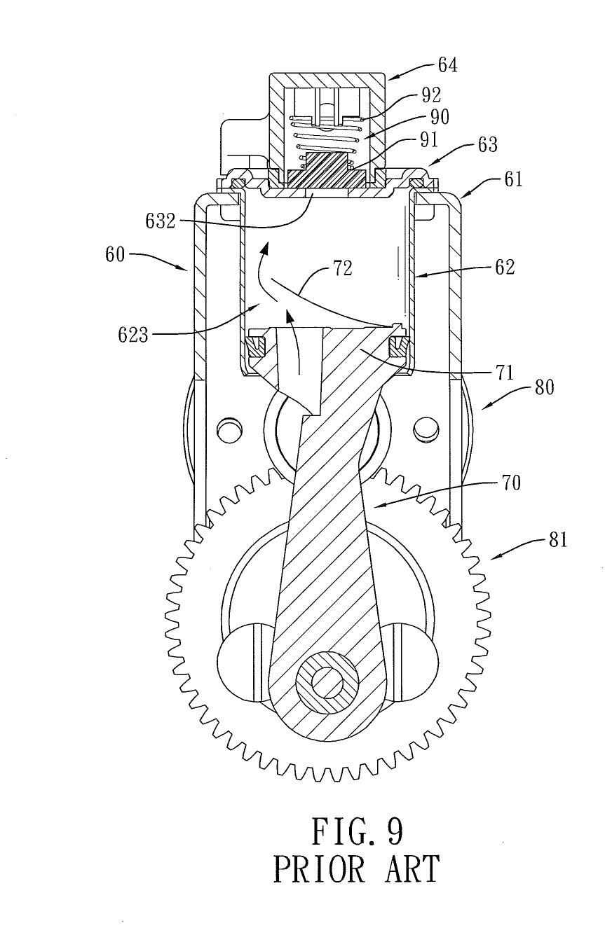

The air pump cylinder 1 in accordance with the present invention is applied to an air pump that comprises a drive mechanism. The drive mechanism may be manual or electric. The drive mechanism as shown is electric and includes a motor 5 and a gearing 6. In operation, the motor 5 drives the piston rod 2 to move in a reciprocating motion in the piston chamber 23 of the housing 20 via the gearing 6. With reference to FIG. 4, each time the piston 3 of the piston rod 2 is moved toward the valve 7, air is compressed by the piston 3. The compressed air pushes the body 8 against the restoring force of the spring 9 to open the central hole 24 of the housing 20 and then ejects into the inflatable article through the passage of the first connecting member 32 of the cover 30 for inflating the inflatable article. With reference to FIG. 5, each time the piston 3 of the piston rod 2 is moved away from the valve 7, a negative pressure in the piston chamber 23 is generated so that ambient air can flow into the piston chamber 23 through a check valve 4 of the piston rod 2. Thus, a pumping effect is achieved.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. An air pump cylinder comprising:
a mounting bracket made of metal and including:
a rear wall having a rear projection extending therefrom and having a fastening hole; and
opposite sidewalls, each sidewall having a side projection extending therefrom and having a fastening hole;
a housing made of metal, clamped between the sidewalls of the mounting bracket and including:
a tubular member having a closed top;
a piston chamber defined in the tubular member; and
a central hole formed through a center of the closed top of the tubular member and communicating with the piston chamber;
a cover hermetically attached to the closed top of the housing and including:
a cap having:
a closed top;
an annular sidewall;
a valve chamber defined between the closed top and the annular sidewall of the cap and communicating with the piston chamber through the central hole of the housing; and
a plurality of upper projections extending from an outer surface of the annular sidewall of the cap and corresponding to the projections of the mounting bracket, each upper projection having a through hole in alignment with the fastening hole of a corresponding projection of the mounting bracket, and bolts passing through the through holes of the projections of the cover and screwed into the fastening holes of the projections of the mounting bracket; and
a first connecting member extending from the closed top of the cap and having a passage defined therein and communicating with the valve chamber of the cap; and
an O-ring compressed between the cap of the cover and the closed top of the housing.

2. The air pump cylinder as claimed in claim 1, wherein each sidewall of the mounting bracket has a curved recess formed in an inner surface thereof so as to form a support portion below the recess and the housing is clamped between the recesses and is supported by the support portions.

3. The air pump cylinder as claimed in claim 2, wherein
the recess of each sidewall of the mounting bracket has a flared section adjacent to the support portion; and
the tubular member of the housing has an open bottom being flared and fitted with the flared sections of the recesses of the sidewalls of the mounting bracket.

4. The air pump cylinder as claimed in claim 1, wherein
the rear projection extends from an inner surface of the rear wall of the mounting bracket and the side projections extend from outer surfaces of the sidewalls of the mounting bracket; and
the cap of the cover has three upper projections corresponding to the three projections of the mounting bracket.

5. The air pump cylinder as claimed in claim 2, wherein
the rear projection extends from an inner surface of the rear wall of the mounting bracket and the side projections extend from outer surfaces of the sidewalls of the mounting bracket; and
the cap of the cover has three upper projections corresponding to the three projections of the mounting bracket.

6. The air pump cylinder as claimed in claim 3, wherein
the rear projection extends from an inner surface of the rear wall of the mounting bracket and the side projections extend from outer surfaces of the sidewalls of the mounting bracket; and
the cap of the cover has three upper projections corresponding to the three projections of the mounting bracket.

7. The air pump cylinder as claimed in claim 4, wherein the tubular member of the housing includes an insertion portion formed on the closed top thereof, inserted in the valve chamber of the cap of the cover and having a center through which the central hole is formed.

8. The air pump cylinder as claimed in claim 5, wherein the tubular member of the housing includes an insertion portion formed on the closed top thereof, inserted in the valve chamber of the cap of the cover and having a center through which the central hole is formed.

9. The air pump cylinder as claimed in claim 6, wherein the tubular member of the housing includes an insertion portion formed on the closed top thereof, inserted in the valve chamber of the cap of the cover and having a center through which the central hole is formed.

10. The air pump cylinder as claimed in claim 7, wherein the cover includes a second connecting member extending from the annular sidewall of the cap and having a passage defined therein and communicating with the valve chamber of the cap.

11. The air pump cylinder as claimed in claim 8, wherein the cover includes a second connecting member extending from the annular sidewall of the cap and having a passage defined therein and communicating with the valve chamber of the cap.

12. The air pump cylinder as claimed in claim 9, wherein the cover includes a second connecting member extending from the annular sidewall of the cap and having a passage defined therein and communicating with the valve chamber of the cap.
